(19) United States
(12) Patent Application Publication
(10) Pub. No.: US 2010/0154646 A1
(43) Pub. Date: Jun. 24, 2010

(54) Coffee station

(76) Inventor: Michael J. Calleja, Brisbane, CA (US)

Correspondence Address: Robert Charles Hill, 235 Montgomery Street #821, San Francisco, CA, 94104, US

(21) Appl. No.: 12/317,303

(22) Filed: Dec. 20, 2008

(51) Int. Cl. A47J 31/00

(52) U.S. Cl. 99/290; 99/295

(57) ABSTRACT

A coffee station includes a base with a vertical back plate for mounting flat against a vertical surface, and a horizontal bottom plate for supporting a coffee brewing machine at a convenient height. A series of reinforcing and stiffening ribs are run like stringers vertically inside the back plate and T-intersect with matching ribs that extend tangentially outward on the surfaces of the bottom plate. The tray section lays on surfaces of the horizontal ribs and bottom plate, and has two large pockets. One fits the footprint of the coffee brewing machine, and the other provides a rimmed area to place cups, saucers, and condiments. A front plate with several slots for racking coffee capsules is in front of the back plate on surfaces of the vertical ribs. Magnets, Velcro, or other quick fasteners are used to keep the front plate and tray in place.

### BACKGROUND OF THE INVENTION

1. Field of the Invention

The present invention relates to food preparation equipment, and in particular to a vertical surface mounted coffee station that provides a rack for coffee capsules and a tray to support a coffee maker.

2. Description of Related Art

A new development in self-service coffee and espresso makers has been the coffee capsule. These small, easy-to-use, and disposable aluminum caps pack enough coffee in one sealed capsule to make a cup of espresso. There is very little waste because each user can pick the kind of coffee they want, and prepare it immediately. One company provides individual color-coded capsules that each contain Ristretto, Roma, Livanto, Volluto, Decaffeinatto Lungo, Arpeggio, Decaffeinatto Intenso, Capriccio, Vivalto, and Finezzo varieties of espresso coffee. The capsules are available from only one source, but the machines are being manufactured by several large appliance makers.

The NEPRESSO system by Nestle Nepresso, SA (Paudex, Switzerland), is a “portioned coffee” system that includes coffee capsules and espresso brewing machines. Olivier Fond describes such capsules in U.S. Pat. No. 5,897,899, issued Apr. 27, 1999, and titled CARTRIDGES CONTAINING SUBSTANCES FOR BEVERAGE PREPARATION. A sealed cartridge is loaded into a brewing machine which then punches the cartridge with a needle and injects hot, steaming water. Brewed coffee is forced out under high pressure (19-bar) through a wide mouth filter end with a tear-face, and the espresso drops down into a cup for serving. The spent cartridge can then be then disposed of.

Organizing, displaying, and keeping so many coffee capsules near the brewing machines is a bit of a problem, and many different racks and magazines have been tried. Table top uses can become especially cluttered and confused.

What is needed is a coffee station that can be easily mounted on a wall or other vertical surface, that organizes the capsules in accessible racks, and that is sturdy enough to support a brewing machine and several cups. The whole unit should be easy to mount, simple to assemble, not too hard to clean, and attractive.

### SUMMARY OF THE INVENTION

Briefly, a coffee station embodiment of the present invention includes a base with a vertical back plate for mounting flat against a vertical surface, and a horizontal bottom plate for supporting a coffee brewing machine at a convenient height. A series of reinforcing and stiffening ribs are run like stringers vertically inside the back plate and T-intersect with matching ribs that extend tangentially outward on the surfaces of the bottom plate. The T-intersection of these vertical and horizontal ribs are gusseted and provide a very strong webbing able to carry heavy loads on a tray section. The tray section lays on surfaces of the horizontal ribs and bottom plate, and has two large pockets. One fits the footprint of the coffee brewing machine, and the other provides a rimmed area to place cups, saucers, and condiments. A front plate with several slots for racking coffee capsules is in front of the back plate on surfaces of the vertical ribs. Magnets, Velcro, or other quick fasteners are used to keep the front plate and tray in place.

The above and still further objects, features, and advantages of the present invention will become apparent upon consideration of the following detailed description of specific embodiments thereof, especially when taken in conjunction with the accompanying drawings.

### BRIEF DESCRIPTION OF THE DRAWINGS

FIG. 1A is an exploded assembly in a perspective view diagram of a coffee station embodiment of the present invention;

FIG. 1B is a perspective view diagram of the coffee station of FIG. 1A as seen from the front and to one side;

FIG. 1C is a perspective view diagram, with a partial cutaway of the back plate, of the coffee station of FIGS. 1A and 1B as seen from the rear and to one side;

FIG. 2 is a variation on the configuration of FIGS. 1A-1C, and shows in perspective view a front plate and tray cover with more space and more slots for cups and coffee capsules in a unit of the same width;

FIG. 3 is another variation on the configuration of FIGS. 1A-1C, and shows in perspective view a front plate and tray cover with more space for cups and more slots for coffee capsules, and that accommodates a coffee brewing machine on the right by making the whole unit much wider;

FIG. 4 is further variation on the configuration of FIGS. 1A-1C, and shows in perspective view of a wider base with four sets of ribs, and a front plate and tray cover with more space for cups and more slots for coffee capsules. A coffee brewing machine is accommodated in the center; and

FIG. 5 is further variation on the configuration of FIG. 4, and shows in perspective view of a wider base with four sets of ribs, and a front plate and tray cover with a large space for cups and eight slots for coffee capsules. A coffee brewing machine is accommodated on the right.

### DETAILED DESCRIPTION OF THE INVENTION

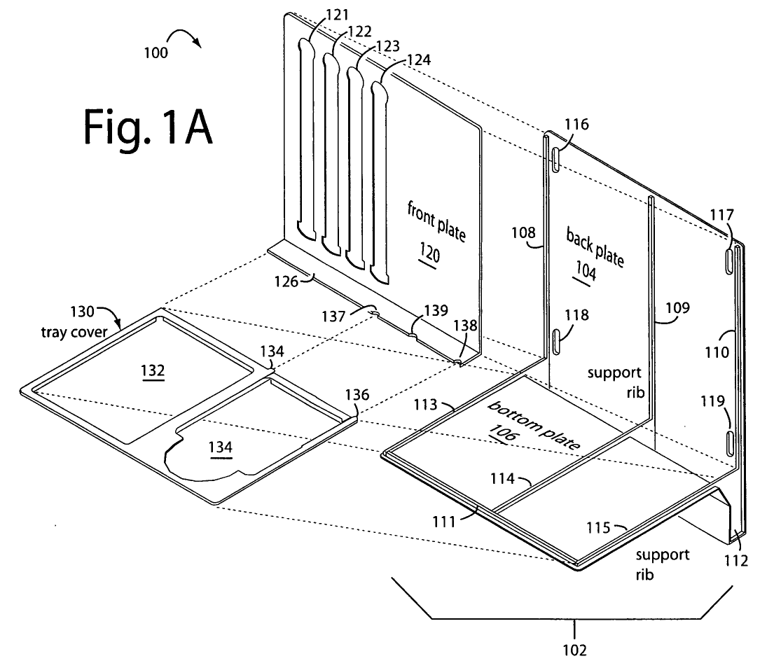

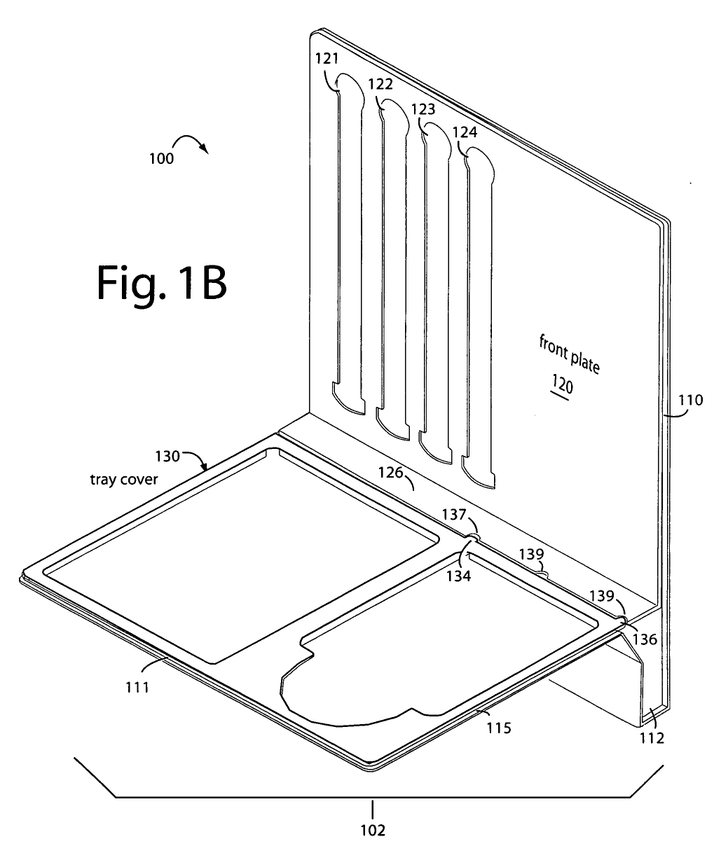

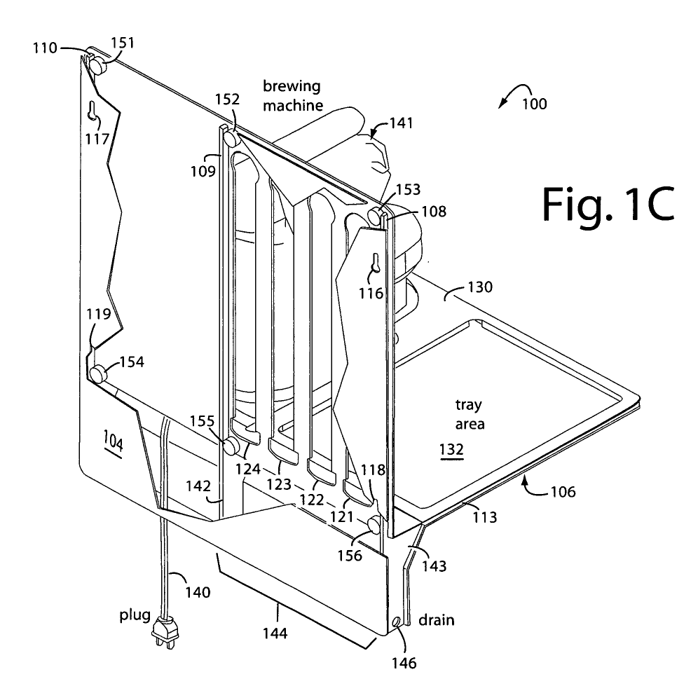

FIGS. 1A-1C represent a coffee station embodiment of the present invention, and is referred to herein by the general reference numeral 100. Coffee station 100 includes a base 102 with a vertical back plate 104 for mounting to a vertical surface, and a horizontal bottom plate 106 for supporting a coffee brewing machine at a convenient height. A series of reinforcing and stiffening ribs 108-110 are run like stringers vertically inside the back plate 104. An edge stringer 111 reinforces the outside edge. The T-intersections of the vertical and horizontal ribs are gusseted, e.g., as seen by a typical gusset 112, and provide a very strong webbing able to carry heavy loads on a tray section. These T-intersect with matching ribs 113-115 that extend tangentially outward on the surfaces of the bottom plate.

A number of slots 116-119 are used to secure the coffee station to a vertical surface. For example, in the United States, for wall mounting these would be set apart left and right by 16″, which is a standard stud spacing in frame construction of walls. At least two such slots would be needed at the top, but as many as four to six total would be useful.

A front plate 120 has several slots 121-124 for racking coffee capsules. For example, Nepresso coffee capsules which are sold worldwide in coffee stores, as well as online (www.nepresso.com). A folded lip 126 provides load support by resting on surfaces of the horizontal ribs 113-115 and gussets like gusset 112. The front plate 120 fastens in front of the back plate 104 on surfaces of the vertical ribs 108-110, e.g. using magnets, Velcro, tape, or other devices.

A tray cover 130 lays on surfaces of the horizontal ribs 113-115, edge stringer 111, and bottom plate 106. The outside edges are all rounded, rolled-over or folded back-under to eliminate any sharp edges. Two large pockets 132 and 134 are cut into the tray cover and flaps along the cut edges are folded down to add strength and stiffness. Pocket 134 is patterned to fit the footprint of a coffee brewing machine, and the other pocket 132 provides a rimmed area in which to place cups, saucers, and condiments. A typical espresso ristretto and lungo brewing machine that could be used here is a NEPRESSO Essenza Espresso Machine.

Interlocking tabs 134 and 136 fit into interlocking notches 137 and 138 to provide registration, a secure fit, and stability between front plate 120 and tray cover 130. A notch 139 is used to thread through a power cord from the brewing machine.

FIG. 1C provides a better view of components that could not be shown well in FIGS. 1A and 1B. A power cord 140 drops down through a slot from a brewing machine 141. It would normally be plugged into a nearby vertical surface outlet. Gussets 142 and 143 are visible in FIG. 1C, and the bottom area between them could be closed to form a sump 144. For example, the sump would be easy to create by bridging the bottoms of back plate 104 and bottom plate 106 between gussets 142 and 143. A drain 146 for a hose can provide a relief for any coffee spilt in the tray area of pocket 132 and other wastes that flowed down into sump 144.

The front plate 120 could be held onto the back plate 104 by several permanent magnets 151-156 affixed with glue or epoxy. Tray cover 130 could also be attached with the aid of several magnets in key locations. The magnets could be glued or screwed to one or the other of the plates, and the magnetic attraction would keep them together until they were intentionally pried apart. Round button magnets could be used as shown, or flexible strips of magnets like those used to seal refrigerator doors closed would also work.

Base 102, front plate 120, and tray cover 130 may be constructed of injection-molded plastics, stainless steel, sheet and bar aluminum welded together, and other materials commonly used in kitchen appliances. They can all be fastened together using any number of conventional methods.

In operation, the gussets 112, 142, 143, provide the strength needed in the tray area when a lever on the brewing machine 141 is pressed down hard to puncture a new coffee capsule and initiate the brewing process.

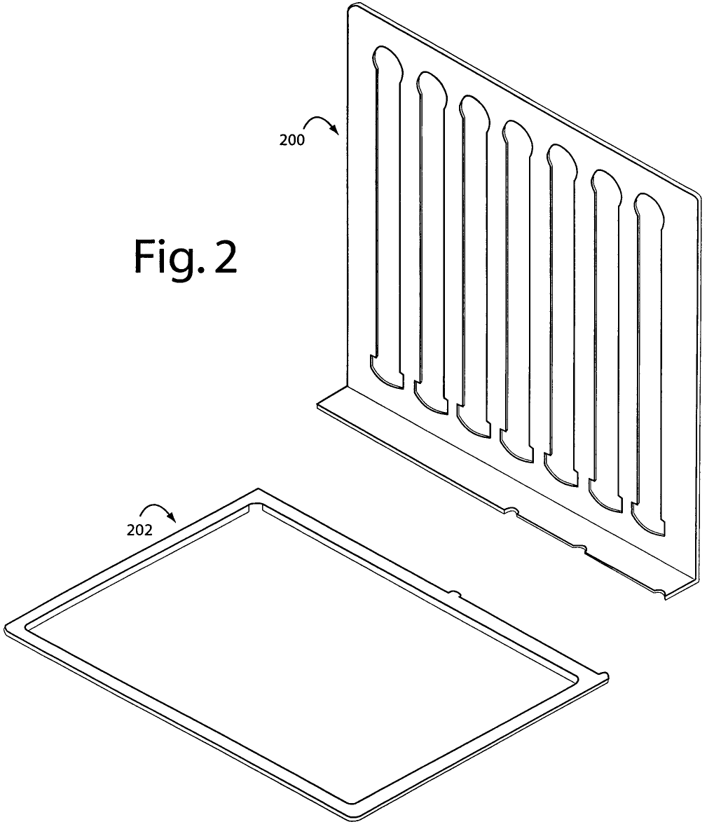

FIG. 2 is a variation on the configuration of FIGS. 1A-1C, and shows in perspective view a front plate 200 and tray cover 202 with more space and more slots for cups and coffee capsules in a unit of the same width as coffee station 100.

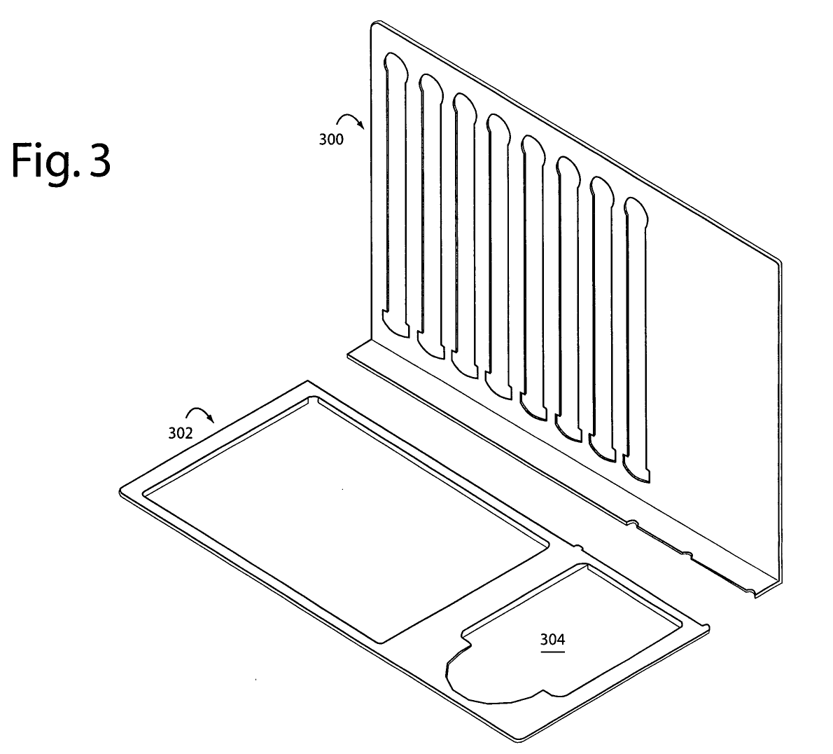

FIG. 3 is another variation on the configuration of FIGS. 1A-1C, and shows in perspective view a front plate 300 and tray cover 302 with more space for cups and more slots for coffee capsules, and that accommodates a coffee brewing machine on the right in a pocket 304 by making the whole unit much wider than those of FIGS. 1A-1C and 2.

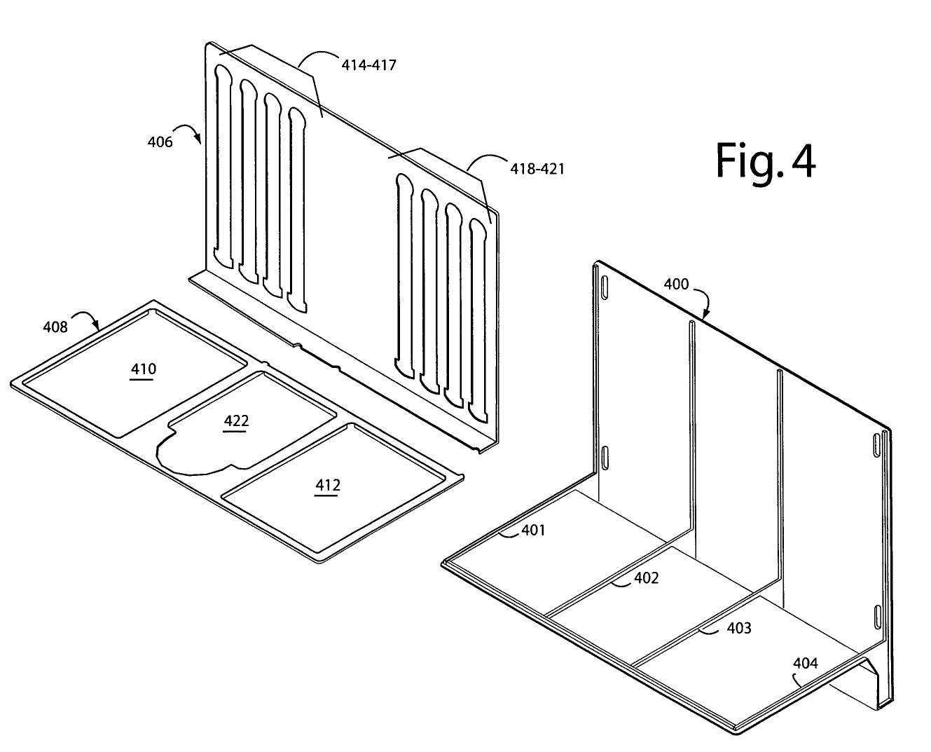

FIG. 4 is further variation on the configuration of FIGS. 1A-1C, and shows in perspective view of a wider base 400 with four sets of ribs 401-404, and a front plate 406 and tray cover 408 with more space 410 and 412 for cups and more slots 414-417 and 418-421 for coffee capsules. A coffee brewing machine is accommodated in the center in pocket 422.

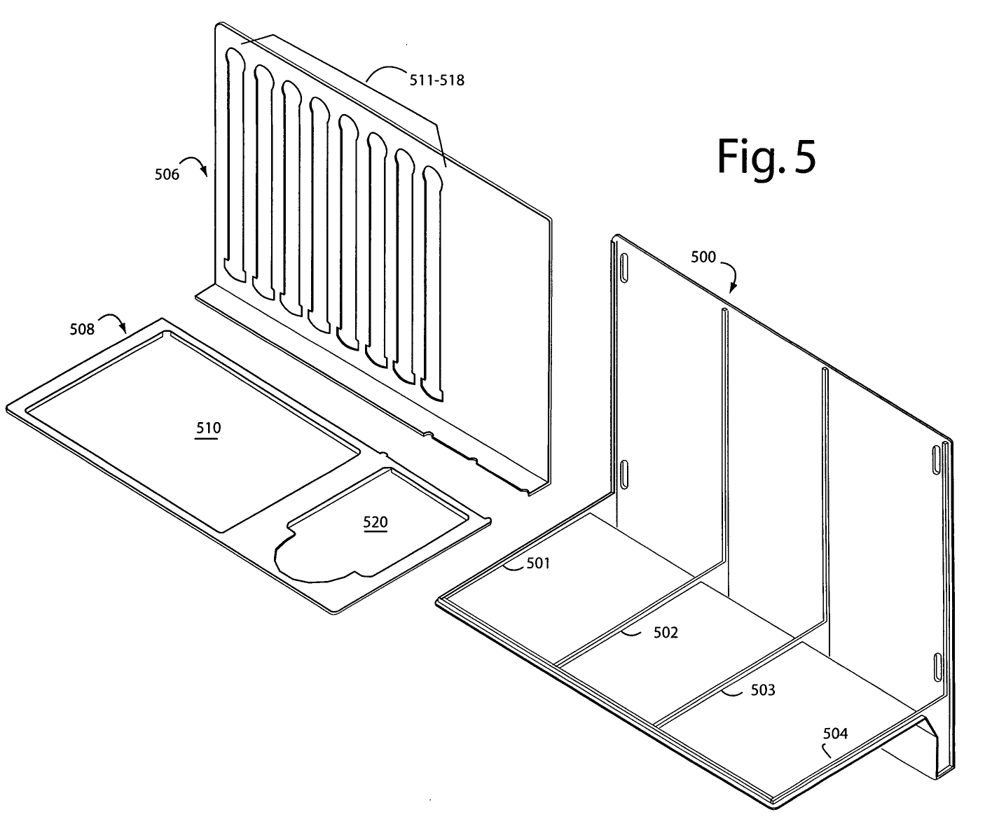

FIG. 5 is further variation on the configuration of FIG. 4, and shows in perspective view of a wider base 500 with four sets of ribs 501-504, and a front plate 506 and tray cover 508 with a large space 510 for cups and eight slots for coffee capsules 511-518. A coffee brewing machine is accommodated on the right in a pocket 520.

Although particular embodiments of the present invention have been described and illustrated, such was not intended to limit the invention. Modifications and changes will no doubt become apparent to those skilled in the art, and it was intended that the invention only be limited by the scope of the appended claims.

The invention is claimed, as follows.

1. A coffee station, comprising:
a back plate for mounting flat against a vertical surface;
a horizontal bottom plate for supporting a coffee brewing machine;
a series of reinforcing and stiffening ribs on the back plate, and strung horizontally on surfaces of the bottom plate;
a corresponding set of gussets at T-intersections of each of the horizontal and vertical ribs;
a tray cover disposed on surfaces of the horizontal bottom plate and ribs;
a first pocket disposed in the tray cover that forms a rimmed area;
a second pocket disposed in the tray cover patterned to fit the footprint of a coffee brewing machine; and
a front plate with several slots for racking coffee capsules, and that is secured in front of the back plate.

2. The coffee station of claim 1, wherein:
the tray cover is detachable.

3. The coffee station of claim 1, wherein:
the front plate is detachable and includes devices to secure it to the back plate during use.

4. The coffee station of claim 1, further comprising:
a number of slots disposed in the back plate and set apart by a distance predetermined to fit a standard vertical surface stud spacing.

5. The coffee station of claim 1, further comprising:
a sump formed between the gussets and back plate and bottom plate, a providing for the collection of liquids spilt through the first or second pockets.

6. The coffee station of claim 1, further comprising:
interlocking tabs and notches on mating edges of the tray cover and front plate to register and secure the combination.

7. The coffee station of claim 1, further comprising:
a number of magnets positioned to retain the front plate to the back plate.

8. The coffee station of claim 1, further comprising:
a number of magnets positioned to retain the tray cover to the bottom plate.
